(19) United States
(12) Patent Application Publication
(10) Pub. No.: US 2021/0383033 A1
(43) Pub. Date: Dec. 9, 2021

(54) STRUCTURAL CONSTRUCTION SYSTEM EMPLOYING ARCHITECTURAL MODELING

(71) Applicant: Plant Prefab, Inc., Rialto, CA (US)

(72) Inventors: Steve Glenn, Rialto, CA (US); Josh Tech, Rialto, CA (US); James Blakey, Rialto, CA (US); Kranti Deshmukh, Rialto, CA (US); John McElroy, Rialto, CA (US); Amy Sims, Rialto, CA (US); Monder Shoufany, Rialto, CA (US); Andi Krainer, Rialto, CA (US); Keith Fiorey, Rialto, CA (US); Deep Bhattacharya, Rialto, CA (US)

(73) Assignee: Plant Prefab, Inc.

(21) Appl. No.: 16/896,920

(22) Filed: Jun. 9, 2020

(51) Int. Cl. G06F 30/13; G06Q 50/08; G06Q 50/16; G06Q 50/26; G06Q 50/04; G06Q 10/06; G06Q 30/00

(52) U.S. Cl. CPC G06F 30/13; G06Q 50/08; G06Q 50/165; G06F 2111/04; G06Q 50/04; G06Q 10/06313; G06Q 30/018; G06Q 50/26

(57) ABSTRACT

A method for providing a structure is provided. The method includes determining a set of building requirements applicable to the structure, establishing an architectural plan for the structure using a computing device including establishing on a grid sets of modularized structural and nonstructural walls, establishing doors and windows, and establishing locations for plumbing fixtures such that plumbing fixtures are placed in positions avoiding conflict with structural elements in the set of modularized structural walls. The design also calls for dividing the architectural plan into a series of component parts transportable from a remote location to a property, thereby producing a modularized architectural plan and comparing at least one of the architectural plan and modularized architectural plan to the set of building requirements and assessing whether at least one plan aspect fails to satisfy the set of building requirements.

### BACKGROUND OF THE INVENTION

### Field of the Invention

The present invention relates generally to the field of construction of structures, and more specifically to tools making the structural design process more efficient

### Description of the Related Art

Many current on-site building construction techniques require numerous suppliers and contractors to provide the necessary elements, such as raw materials, in combination with the labor necessary to complete each step in the process for producing a structure, such as a single family home. Many people and building materials are required to be at the site at appropriate times.

On-site construction may in some instances suffer schedule delays and budget overages resulting from unforeseen site conditions, such as inclement weather or permit delays, changing site conditions, subcontractor unavailability, expensive local labor or lack of readily available raw materials. Project managers responsible for constructing buildings within budget and on-schedule must coordinate numerous steps that are challenging to schedule and in some instances wholly unpredictable. The process of on-site building construction has been described as “controlled chaos.”

Currently, some developers employ prefabricated construction techniques in erecting portions of the building, or the entire structure. Present pre-fabrication techniques often reduce the time and cost associated with traditional non-prefabricated construction techniques. “Prefabrication” or “systems built housing” construction techniques typically involve one of four major market segments: manufactured, modular (which can be divided into custom and semi-custom), panelized, and pre-cut or kit homes. Each involves pre-formed materials, and all but manufactured homes must typically comply with local building codes.

Manufactured homes are complete dwelling units substantially or completely constructed in a factory in conformance with a national building code. They are commonly known as mobile homes. Modular homes are factory assembled residences built in units or sections, transported to a permanent site and erected on a foundation. Unlike manufactured homes, modular homes conform to local building code(s). Again, modular homes can be either custom or semi-custom. Custom prefabrication generally involves multiple modular boxes, or volumes, built to size, compliant with local codes, that define the desired final space, room, or portion thereof. Each modular box must be individually “engineered” to ensure adequate strength (e.g. shear and vertical loading), code compliance, and other structural design details. Buildings realized from custom prefabrication can require months of additional “engineering” and code compliance verification prior to beginning of each building project. Due to the customized nature, this technique currently can be problematic as it does not typically benefit from standardized parts. The modular “boxes” produced by today's custom methods resemble empty volumes “full of air” as the box is lacking in infrastructure, e.g. HVAC, electrical, and plumbing. Custom methods are of limited benefit due to necessary individualized design/engineering efforts and the fact that the custom process generally provides no repeatable, reusable, or standardized components or economies of fabrication.

Semi-custom prefabrication methods typically involve a limited set of, for example, five to twenty complete individual building designs. Since the designs are known in advance, semi-custom prefabrication methods may enable configuring and building a limited set of components prior to construction. Many semi-custom designs involve choosing a pre-determined building design and constructing on-site with no modifications. In the situation where some customization is available, the resulting designs become are limited and can require re-engineering and re-approval of the initially selected building design. Semi-custom designs are further limited in that they typically require provisioning of space within multiple areas of the structure to accommodate addition of various custom features such as a tank-less in-wall water heater for a bathroom. Semi-custom designs become problematic in that the need for establishing or provisioning reserve space can be inefficient and may inhibit component standardization, resulting in higher overall costs.

As may be appreciated, certain advantages and disadvantages are associated with each type of housing construction technique. Certain modular systems can offer advantages in that most aspects of the construction of the building, such as finished plumbing, windows, electrical, drywall, cladding, millwork, tiles, etc, can be completed aS site work is being completed, saving time and money. This can minimize delays due to weather, use of tools can be leveraged, and supplies can be centralized and readily available to all trades.

Prefabrication construction of manufactured or “mobile” homes is in accordance with Housing and Urban Development (HUD) codes. The mobile homes produced from manufactured systems are mostly produced in a factory as a single complete structure. By HUD code, mobile homes must be transportable, with wheels attached to their foundations, and must be capable of being moved after installation. The mobile home is transported on a single vehicle or transported in a limited number of large sections and fixed at a semi-permanent location. Due to the need to transport the dwellings on roadways, the total size of the structure is governed by inter- and intra-state vehicle codes. Systems such as these are limited, in that multi-family dwellings are not permissible according to current HUD codes.

Panelized prefabrication methods generally involve constructing only the building walls at a factory. The walls may be efficiently packed and shipped to the on-site construction location. Panelized methods may afford flexible designs and allow for standardizing certain components, for example one component may be a wall with a door, where a different component may involve a window in lieu of or in combination with a door. Panelized methods become problematic because existing panels typically involve only framing, or framing and installation, and the builder still must provide electrical, plumbing, cladding, dry wall, millwork, and so forth, on site. As a result, the builder is subject to all the uncertainty and vagaries of site based construction, issues modules do not have. Panelized methods are typically limited to wall components and do not generally entail ceilings, floors, decks, roofs and other horizontally oriented “wall-like” components. The lack of horizontal components and the inability to define spaces for inclusion of desired features can result in increases in on-site assembly efforts, increasing costs and delaying schedule.

Off-site constructing of repeatable standardized modules and panels buildings components in a controlled environment as a hybrid building system may eliminate many of the budget and schedule challenges associated with site-based construction methods.

One design used in construction of such structures is disclosed in U.S. Pat. No. 8,621,818, inventors Steve Glenn, et al., issued Jan. 7, 2014, the entirety of which is incorporated herein by reference.

While systems such as shown in the Glenn patent provide advantages over previous designs, additional benefits may be realized by enhancing such a design to enable architects to realize any custom design. The present design can work with software used by architects to more easily design homes utilizing efficient manufacturing and installation techniques, such as those represented in the '818 patent. Such functionality accounts for and allows design including interior components such as sinks, bathtubs, toilets, islands, shelving, large appliances, and so forth. Different sized components can present challenges to the design and sizing of the room and walls. Many existing designs offer a uniform “box” for a given room such as a kitchen or bathroom without regard to logistical considerations of the placement of such components.

It would be beneficial to provide a building construction methodology that combines standardized module and panel building fabrication aspects with the ability to assess and/or establish the location of desired components in completed standardized modules that overcomes the issues and limitations of current devices and arrangements.

### SUMMARY OF THE INVENTION

Thus according to one embodiment, there is provided a method for providing a structure, comprising determining a set of building requirements applicable to the structure, establishing an architectural plan for the structure using a computing device, comprising establishing on a grid a set of modularized structural walls a from a set of available modularized structural walls using the computing device, establishing on the grid a set of modularized nonstructural walls from a set of available modularized nonstructural walls using the computing device, establishing doors and windows in association with the set of modularized structural walls and the set of modularized nonstructural walls using the computing device, and establishing locations for plumbing fixtures in selected regions within the set of modularized structural walls and the set of modularized nonstructural walls using the computing device such that plumbing fixtures are placed in positions avoiding conflict with structural elements in the set of modularized structural walls. The design further includes dividing, using the computing device, the architectural plan into a series of component parts transportable from a remote location to a property, thereby producing a modularized architectural plan, and comparing at least one of the architectural plan and modularized architectural plan to the set of building requirements and assessing whether at least one plan aspect fails to satisfy the set of building requirements.

According to a second embodiment, there is provided a method for providing a structure, comprising architecturally designing the structure, wherein architecturally designing the structure comprises establishing an architectural plan for the structure using a computing device, comprising establishing on a grid a set of modularized structural walls using the computing device, establishing on the grid a set of modularized nonstructural walls using the computing device, establishing doors and windows to be provided with the set of modularized structural walls and the set of modularized nonstructural walls using the computing device, and establishing locations for plumbing fixtures using the computing device in positions avoiding conflict with structural elements in the set of modularized structural walls. The design further includes dividing, using the computing device, the architectural plan into a series of component parts transportable from a remote location to a target property, thereby producing a modularized architectural plan and comparing at least one of the architectural plan and modularized architectural plan to a set of building requirements and assessing whether at least one plan aspect fails to satisfy the set of building requirements. The design further includes producing a final modularized architectural plan and preparing physical modular components according to the final modularized architectural plan and transporting the physical modular components to a target site and installing the physical modular components to build the structure.

According to a further embodiment, there is provided a method for providing a structure, comprising establishing an architectural plan for the structure using a computing device, comprising establishing on a grid a set of modularized structural walls using the computing device, establishing on the grid a set of modularized nonstructural walls using the computing device, establishing doors and windows to be provided with the set of modularized structural walls and the set of modularized nonstructural walls using the computing device, and establishing locations for plumbing fixtures using the computing device in positions avoiding conflict with structural elements in the set of modularized structural walls. The design further includes dividing, using the computing device, the architectural plan into a series of component parts transportable from a remote location to a target property, thereby producing a modularized architectural plan, and comparing at least one of the architectural plan and modularized architectural plan to a set of building requirements and assessing whether at least one plan aspect fails to satisfy the set of building requirements.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 illustrates the overall system;

FIG. 2 shows a structural grid generated by the present design;

FIG. 3 is a general functional embodiment of the present design;

FIG. 4 illustrates placement of walls on the structural grid;

FIG. 5 shows an architecturally established structure including walls, windows, and doors;

FIG. 6 represents identification of a region requiring at least one plumbing fixture;

FIG. 7 shows an example of a plumbing grid layout in a selected region;

FIG. 8 shows placement of plumbing fixtures on a plumbing grid that avoids conflict with structural members;

FIG. 9 is a near-complete structural representation;

FIG. 10 shows modularized components of a near-complete architectural structure;

FIG. 11 illustrates options made available to a designer;

FIG. 12 shows general functional operation according to an embodiment of the present design;

FIG. 13 is a representation of a bathroom design showing fixture locations relative to structural elements; and

FIG. 14 illustrates a hardware example embodiment according to the present design.

### DETAILED DESCRIPTION

The following description and the drawings illustrate specific embodiments sufficiently to enable those skilled in the art to practice the system and method described. Other embodiments may incorporate structural, logical, process and other changes. Examples merely typify possible variations. Individual elements and functions are generally optional unless explicitly required, and the sequence of operations may vary. Portions and features of some embodiments may be included in, or substituted for, those of others.

In general, the present design includes a system and method for assessing and establishing plant building system compliant designs, i.e. establishing structural designs that can be manufactured offsite and can, for off-site creation and prefabrication of standard components, integrate beneficial aspects of mobile construction to form a hybrid building construction system and methodology that satisfies known building requirements.

The present design establishes structures in a way to ensure that parts of the home that require skilled labor—baths, kitchens, utility cores—are isolated into modules. The present design gives architects and other designers access to certain information about structural components, including environmental performance and pricing, so that they can design better buildings faster, reducing the need for value engineering. The present design enables architects to obtain information from the system as structures are sized and elements placed that can be used to inform such individuals on design choices and options.

Another aspect of the present design identifies local ordinances and other building requirements and determines module sizing and/or attributes such that components can be provided therein. Logistical components are also assessed. For example, electrical plug requirements may dictate where electrical components may be placed, while in certain instances toilets should be located a certain distance from a sink. Local building codes may dictate door clearances or that doors may not swing out over stairs, for example. The present system assesses these requirements, makes accommodations or recommendations and enables the user or construction entity to make changes that will be acceptable to the government or the party commissioning the structure.

Note that as used herein, the terms “modules” “components” and “elements” are generally employed to mean modules are the largest building related unit, and modules include certain components formed of elements. Building systems may include panel components, and panel components may include but are not limited to walls, floors, roofs, and decks. Building system module components may configure predefined functional building blocks to form upper, lower, and mid-level positioned modules. Functional building blocks may include but are not limited to stairs, kitchens, built-in such as a home theater wall unit or other fixture, master baths, baths, and studios arranging a kitchen and bath combination. The present design building system may assess requirements and desires and configure relevant components, such as modules and panels, enabling construction of such components that are in turn suitable for mobile transport to the building lot or site for assembly.

The standard components of the present design may enable sizing of modules, components, and elements, and placement of items such as appliances and fixtures in the modules so established. Such assessment and sizing facilitate the installation and integration of various infrastructure functional elements including but not limited to plumbing and electrical, HVAC ducting, structural framing, interior finish, exterior cladding, special purpose materials, such as thermal or sound insulating, structural, etc., and non-structural cavity furring. Space or provisions may be made for these infrastructure functional elements such that they are available when the components are fabricated and transmitted from the factory such that connections can be made at the job site.

The present design may involve pre-installation preparation of portions of predefined or standardized modules where each module is configured to include all equipment integrated into a fully finished, ready-for-use, room arranged to fulfill specialized functions, such as a kitchen or bath. The present design may make assessments and recommendations and establish measurements enabling combining of relatively standard modules (kitchen, bath, bedroom, etc.) with standard panels that enable connection of the standard modules

Standard panels may be assembled or fabricated with infrastructure elements or integrated services (electrical outlet boxes, insulation, HVAC ducts, etc.) or without. Panels containing few or no integrated services, together with panels that include infrastructure functional elements for providing services, may be arranged together as desired to connect modules together. Different such panels may be employed to define remaining spaces required that are not satisfied by the use of modules (hallways, staircase landings, etc.)

The present design enables the architect, engineer, builder, or owner to accurately specify virtually all components of a potential structure that will in virtually all cases pass inspection. As a result of the assessment according to the present design, the designer can increase or decrease the overall size of the final building superstructure as desired by changing (increasing or decreasing) the number of modules or panels, the size of modules or panels size, and the layout or contents of connected panels to alter dimensions of the building's defined spaces.

Again, reference is made to a system for construction of structures as disclosed in U.S. Pat. No. 8,621,818, inventors Steve Glenn, et al., issued Jan. 7, 2014, the entirety of which is incorporated herein by reference. The '818 system discloses panelized construction of structures or dwellings that permits pre-installation fabrication of building modules and panels integrating functional elements that typically would be fabricated and constructed on-site.

The present design provides a system for assessing construction plans in light of building restrictions and either with alterations provided by the designer or other appropriate entity, changing the design such that in most if not all cases the resultant structure may be fabricated, transported and assembled within relevant parameters, including government requirements, thereby minimizing waste.

The present design serves to increase architects' awareness of limitations when offering a building system of panels, components, etc., and also serves to empower architects to design compliant structures, improving the manufacturing-readiness of architectural models for fabrication and assembly/construction, and allows architects and designers to obtain “quick bids” or Rough Order of Magnitude (ROM) estimates for projects during the design phase. The present design may operate as a stand alone software package or may operate as a plug-in tool that uses constraints, dialogues, libraries, and other software functionality to achieve desired objectives.

One embodiment of the design includes specific wall, floor, and roof systems with materials and thicknesses that correspond to standard wall panel construction methods, such as those reflected in the '818 patent identified above. Such an embodiment may have maximum and minimum lengths and heights limited by manufacturing and shipping constraints. Where walls exceed maximum lengths or heights, the system splits or divides the walls to demonstrate that construction requires more than one wall panel. Floor and roof systems have maximum and minimum lengths and widths limited by manufacturing and shipping constraints. Once the user establishes an outline for the floor or roof, the system splits these elements to illustrate panel sizing and location(s). The system prohibits the user from placing windows and doors at split lines between walls, requiring the user to either place the window elsewhere or move the split wall line. The system creates maximum lengths, heights, and elevations for windows and doors limited by manufacturing and shipping constraints. The user may override these limits, but the system will issue a warning. The design uses the lengths and widths of rooms, and the presence of objects (such as kitchen or bathroom plumbing fixtures) to determine which rooms the entire system can plan, construct, and deploy as core modules. The system generates a Rough Order of Magnitude (ROM) project cost estimate based on square footage of the structure. The ROM estimate may vary based on a selection of finish level desired (e.g., low cost, average cost, or high cost).

The design may include a BIM (Building Installation Modeling) library of standard kitchen and bathroom fixtures, appliances, windows and doors, HVAC equipment, and other standard items. The system further performs clash detection for mechanical, electrical, plumbing, and structural systems, and provides a catalog of standard structural and architectural 2-D details such as typical shear wall details, wall-floor-foundation connection details, etc. The system may generate these details based on climate, seismic zone, wind zone, or other project-specific geographic categories. Additionally, responsibilities between the various entities involved (manufacturer, contractor, owner, etc.) may be provided, and the system may indicate building surfaces that are fully finished (e.g., with drywall or flooring) during installation or surfaces finished on-site. Shipping feasibility, shipping costs, and installation feasibility are assessed and made available.

Currently available systems for building construction include BIM, or building installation modeling, systems. Such systems, used or usable with packaged or otherwise available software such as Autodesk and/or Revit, provide benefits in construction including ability to cost projects, allowing multiple individuals to collaborate, and more efficient scheduling. However, certain aspects of interest are limited. The present design offers an ability to assess attributes such as carbon footprint of the components of a design and/or the entire design, collisions between elements, waterproofing attributes of components, information of performance of components, and so forth. The present system thus supplements current designs in providing a further level of detail as to the proposed structure. A key attribute of the present design is the ability to do all this in a way that is optimized for prefabrication.

The system thus allows for determining and providing recycling attributes of building materials, size and weight of modules/panels, a listing of building specifications to the lowest possible level (e.g. nails, etc.), lead time(s) for items (e.g. plumbing fixtures), a library of available materials, a library of building components (wall, floor, roof . . . ) filterable by region/climate zone, and cost of upgrade options (e.g. stainless steel flashing vs. galvanized sheet metal). The system may also provide a list interface enabling the user to enter items based on type. For example, for a window, the system asks for manufacturer, opening type, frame material, frame color, glazing type, hardware, and so forth. For tile, the system asks for tile manufacturer, color, finish, size, pattern, and for grout, manufacturer, type, color, gap spacing, etc. The system further provides standard construction details, generates structural calculations and engineering, calculates heating and cooling loads, projects annual resource consumption based on number of users, location, installed appliances and fixtures, and creates a BIM model available to the end user/customer where he or she can see the spec information. For example, the user may select a light fixture and the system may indicate manufacturer, type, product number including tie in to order a replacement light source, different trim, and so forth.

Further, the system may alert the customer of regular maintenance items (e.g. water heater, AC system tune ups, and so forth. The system may also estimate and provide energy performance simulation over a day/night cycle to include thermal mass, heat gain during the day, cool down period during the night, and benefits of cross ventilation, for example. The system may also generate a scope of work list based on the design and the CSI (Construction Specifications Institute) categories with a default scope distribution between factory, installer, and general contractor.

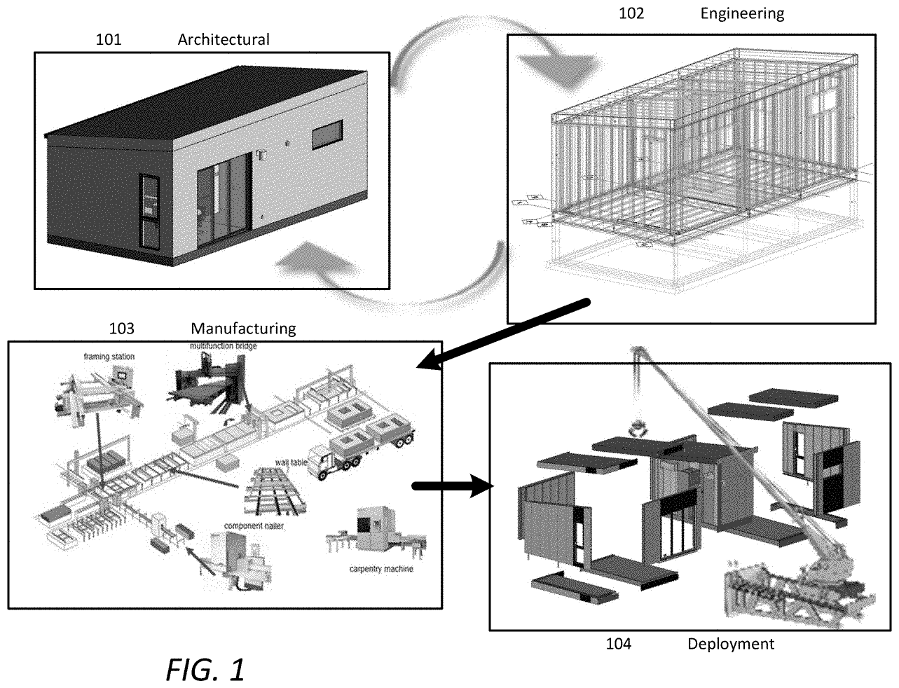

FIG. 1 is a general overview of the functionality of the system. From FIG. 1, a representation of a finished modularized structure is shown representing architectural modeling element 101. Architectural modeling element 101 provides a user with a low fidelity, low detail architectural model, using modeling tools to provide a plant engineering platform or PEP. In this element, architectural design tools employ constraints and apply those constraints to achieve system complaint designs. A data exchange occurs between architectural model element 101 and the visual representation of engineering model element 102. The engineering model element 102 receives a computer aided design model and adds higher fidelity components, producing 3D plans, shop drawings, material usage, bill of materials, and CNC (computer numerical control) data.

The representation of manufacturing instruction element 103 indicates manufacturing instruction element 103 receives the engineered design from engineering model element 102 and produces completed structure modules, components, and elements ready for shipment and on-site assembly. CNC cutting and machining is performed at manufacturing instruction element 103, component options offered or finalized and produced, and modular builds made available. Field and installation deployment element 104 provides sequential palletization of relevant items, including components, elements, panels, and so forth. Field and installation deployment element 104 also provides digital field installation instructions, accessible traceability, and parts.

The focus of the present design is the operation of architectural model element 101 and interaction with engineering model element 102. The design of architectural model element 101 seeks to provide easy to use modeling constraints aligned generally if not completely with system standards, wherein such system standards are standards set in accordance with the fabrication of panels, components, and so forth. Architectural model element 101 may be computer implemented, and may be part of or an additional component to an existing software profile. As an example but not by way of limitation, the Revit or Autodesk software suite may be employed with additional functionality as described herein.

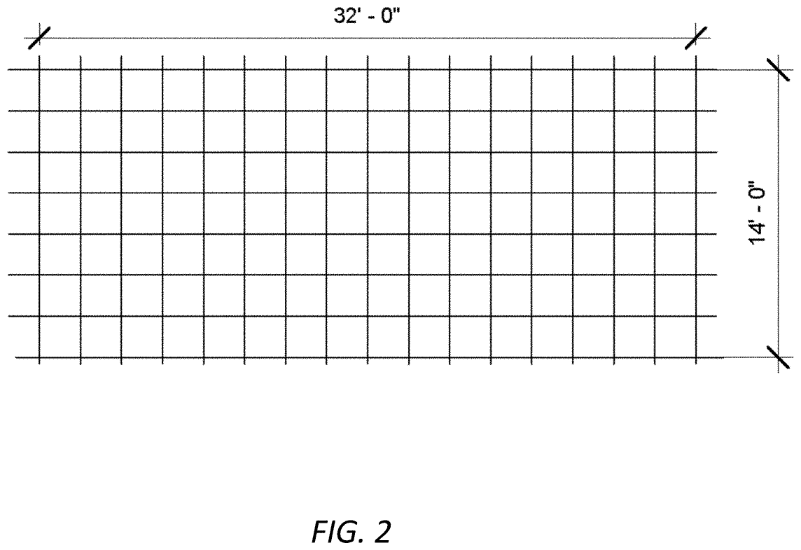

FIG. 2 shows an example grid produced by architectural software. The grid includes framing lines, or a framing grid 201 and a bath grid 202. The present design takes grids, such as those shown in FIG. 1, and encourages or requires designers to produce compliant structures within grids. Grids can be changed during the course of architectural modeling. Architectural modeling provides a smart grid such as the one shown in FIG. 1, a window and door elevation grid, and finished module overall dimensions. The present design then offers the ability to audit existing designs or structure layouts or grids. In general two options are offered, the first being identification of a list of noncompliant attributes of the proposed design. The second dynamically provides the designer with issues determined and the designer may change those components and run a further audit. This allows for analysis and optional change making ability in later phases of the design cycle. Functionality provided includes overlaying structural and smart grids, assessing the proposed layout for issues and reviewing the dimensions of finished module spaces for shipping viability.

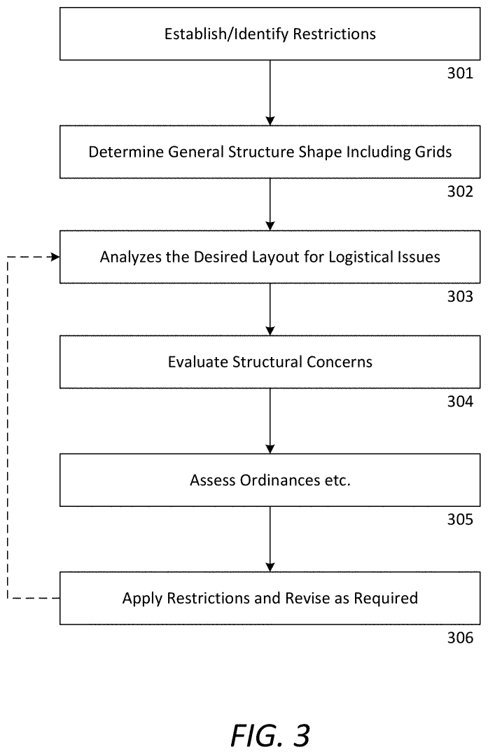

FIG. 3 illustrates the general functionality of the audit function being performed. From FIG. 3, the proposed architectural layout is presented conceptually. The designer may be limited to components or panels or the like that may be manufactured for the proposed structure and limited in the selection of options. For example, if a particular type of wall is desired and cannot be provided, such a restriction limits the designer at point 301. At point 302, the user determines a general structure including grids with layouts for the various rooms, walls, floors, and so forth. The item produced is a desired layout. At point 303, the system analyzes the desired layout for logistical issues. Logistical issues may include simple matters such as ensuring a toilet is provided in a bathroom, walls are provided on the exterior, walls fit together, and so forth. More complicated logistics and assessments may be employed, such as sufficient thickness is available in the walls to provide necessary insulation, materials are available for the desired layout, water, sewage, and electrical services will be available where needed, and so forth. All logistical issues are flagged or identified for later resolution. Point 304 evaluates structural concerns explicitly, ensuring walls and supports are located in a manner adequate to support the entirety of the structure. Point 305 assesses known ordinances, or governmental requirements, and assesses compliance with such ordinances. For example, setback of the structure is typically subject to local ordinances, and thus if part of the front of the structure is too close to the street, the system will identify the issue. Further, the system may evaluate door sizes, window sizes, and so forth for compliance with applicable government requirements. Point 306 provides restrictions imposed by the project, for example having two ten foot by ten foot bedrooms and one master bedroom, two and one half baths, a wall in the living room greater than 12 feet wide, no angled ceilings, and so forth. Any of the points 303 to 306 may be omitted or may be optional, and other restrictions or requirements may be applied as desired. The result of these assessments is a flagged desired layout, wherein flags are applied to issues with the desired layout.

At this point, the design may be altered manually by a designer. Alternately, the system may perform improvements to the desired layout, such as when a sink is missing from a half bath the system may determine logical positions for the sink, or the system may provide options, e.g. a sink may be placed in position A or position B or position C. The system may provide other alterations or suggestions, such as moving components or elements, resizing components, elements, or panels, or otherwise determining alternatives to flagged items resulting from the foregoing processing. Thus according to the present design, the system may offer optional changes, may make changes, and/or may simply identify issues that may be addressed by a designer.

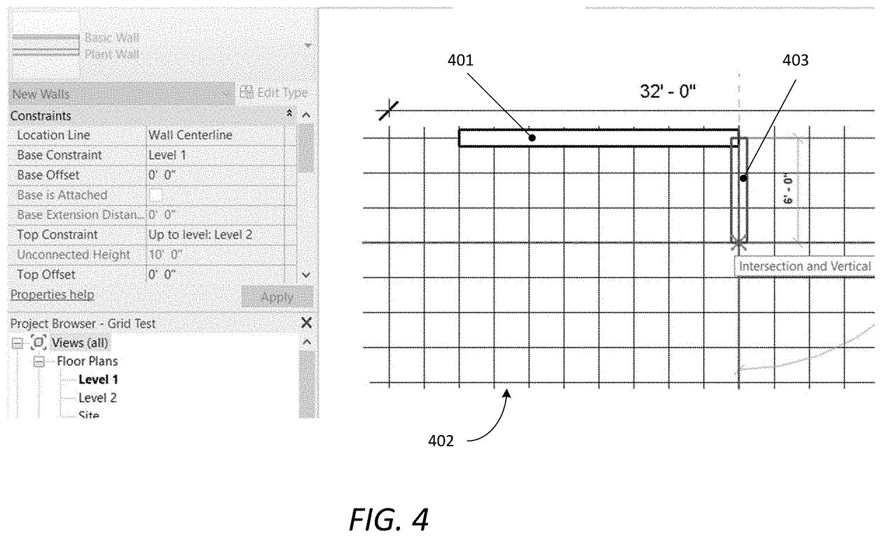

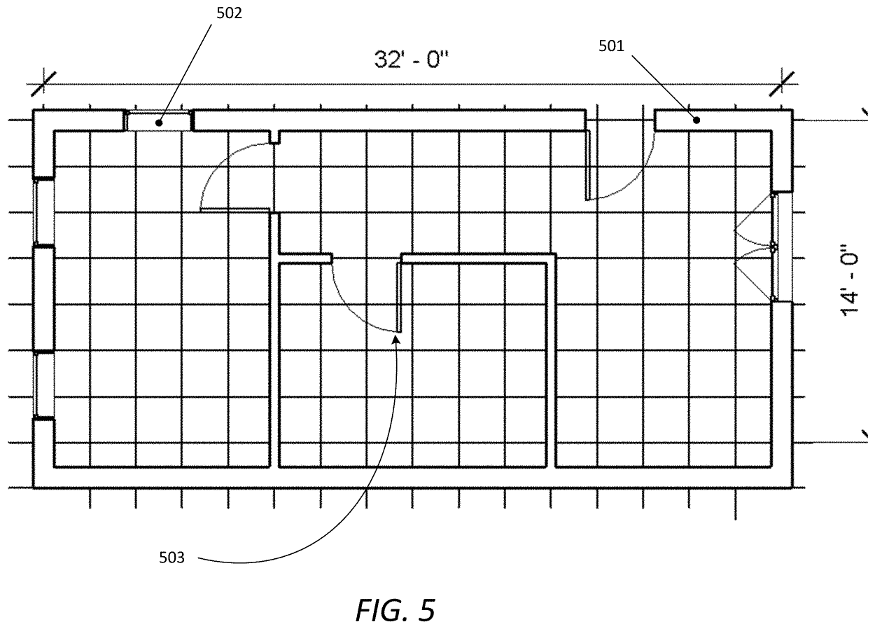

Production of the desired layout begins with the representation of FIG. 4. From FIG. 4, the user may select, for example, a wall item and may place and size the selected wall 401 on a grid 402. Grid size may vary, but may be 12, 18, or 24 inches, or any desirable value. A second wall 403 may be placed, and the designer may proceed putting walls in desired locations. FIG. 5 illustrates a representative structure including walls, doors, and windows produced using the tool. Wall 501, window 502, and door 503 are representative components of the structure represented.

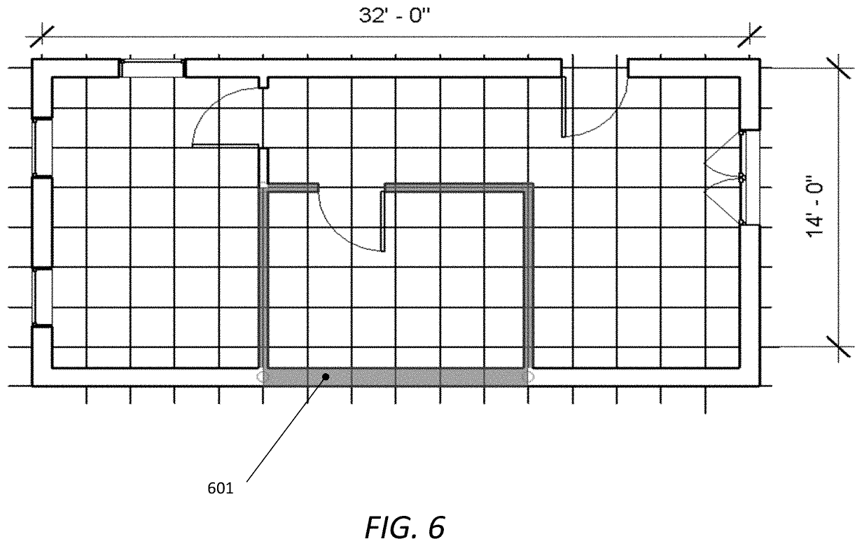

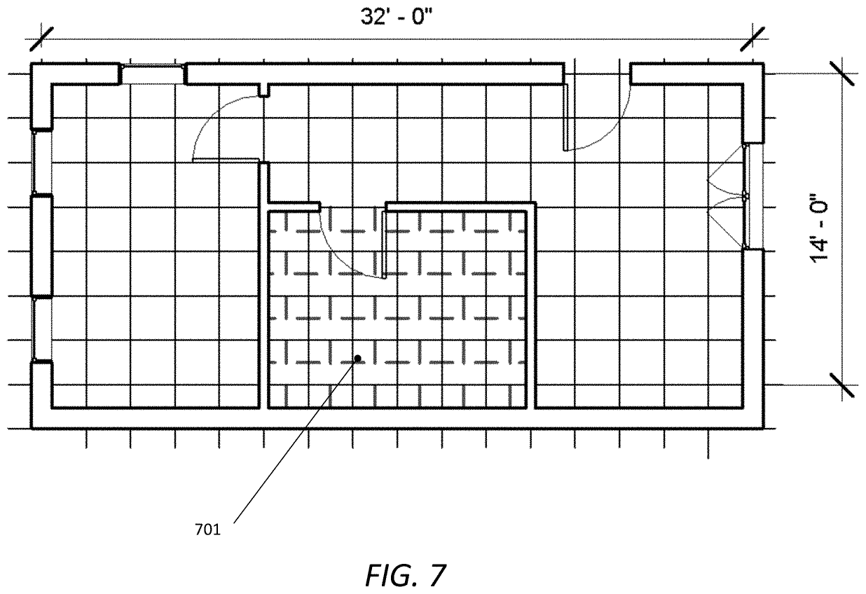

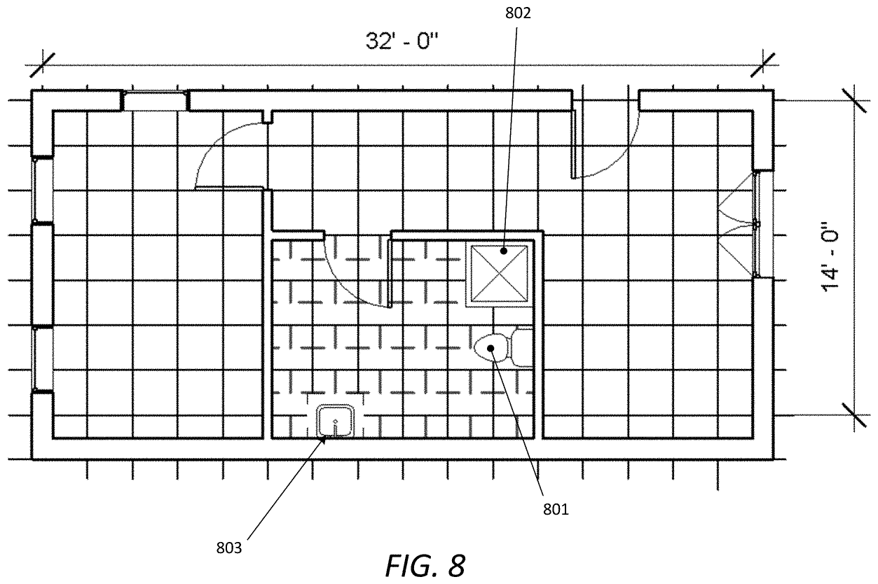

FIG. 6 represents the user selecting a region 601 and designating the region 601 as a bathroom such that the system applies bathroom rules or tools to the selected region. FIG. 7 shows the bathroom region having a plumbing fixture grid 701 applied. FIG. 8 represents plumbing fixtures provided on the plumbing fixture grid, including toilet 801, shower 802, and sink 803. From this, plumbing can be established. Presence of the plumbing grid can avoid placements that conflict with framing members.

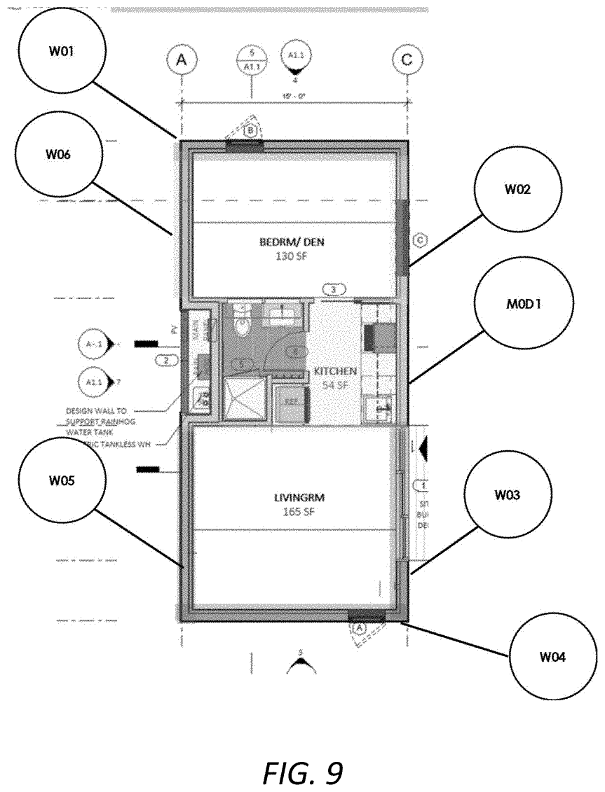

FIG. 9 illustrates a version of the desired layout with the design near complete. At this point, the system may identify components of the desired layout that can be separately constructed and provided as part of a modular structure. Walls, for example, can be separately or modularly produced in various instances. The system may identify smaller pieces or components, such as cripple walls, walls including certain windows, stairs, and so forth as components that may be modularized or separately constructed, transported to a building site, and put in place at the proper time. Thus the present design may include a modularization tool that generates a sample scheme for the modular structure based on, for example, certain design constraints such as manufacturing, shipping, and/or installation capabilities. The tool first identifies parts, creates parts, and may divide parts as necessary.

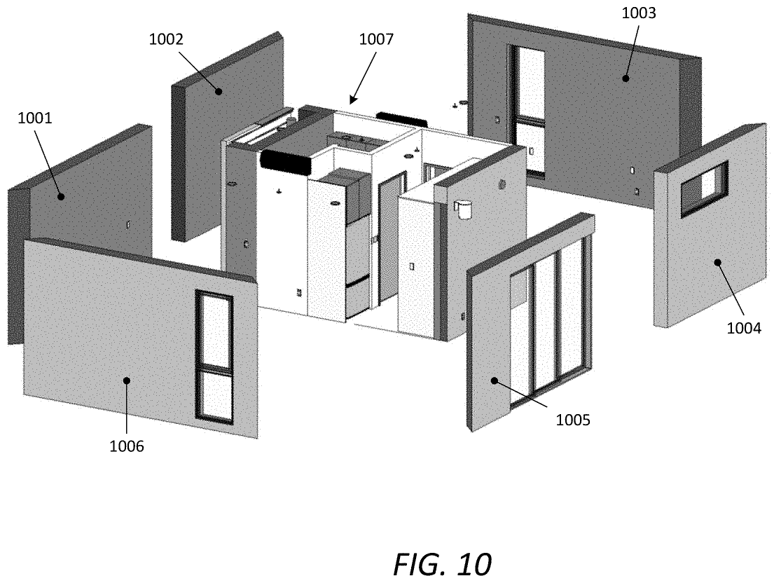

FIG. 10 shows an exploded version of the results of the modularization tool, wherein separately constructable components are identified, including wall panels 1001 through 1006. Some of these panels include windows or doors but can be constructed and assembled on site. Modular component 1007 is shown in a single piece, but the modularization tool may separate pieces of modular component 1007 for separate fabrication and later assembly and installation.

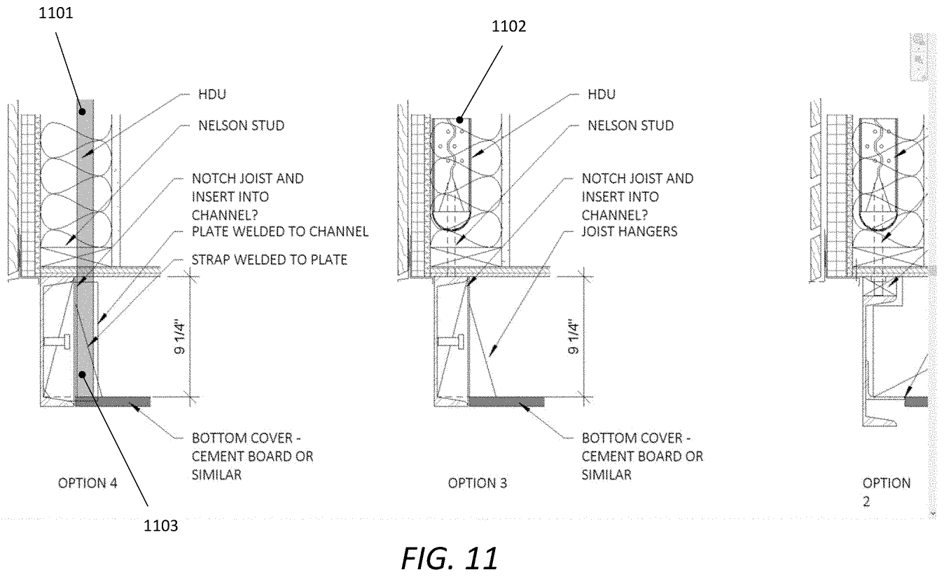

FIG. 11 illustrates a number of options presented to the designer. In this instance, different structural components are offered, including support element 1101 in option 4 as opposed to support element 1102 in option 3. A bottom portion of support element 1101 is shown as base element 1103 and is missing from option 3. Such alternatives may be determined by the system where appropriate, may be selected as possibilities by the designer, or may be offered as separate selections available for inclusion in a design.

The system may at this point alter the design or offer alterations or options to the designer in the form of a flagged desired layout and issues addressed either by the system or by the designer. The system provides the resultant established layout to the engineering model element of FIG. 1, and the resultant established layout is converted to a detailed engineering model with associated machine data ready for production. Issues found in creating the engineering model may be addressed back to the architectural model for correction. The solution and action taken depend on the issue raised. If a wall is not sized properly or will not fit or does not offer required support, the engineering model may return the plans to the architectural model with the issue identified. The architectural model may be employed to change the noted feature, offer options that may be selected, and/or is changed by a designer. This back and forth between the architectural model and the engineering model may occur several times as needed.

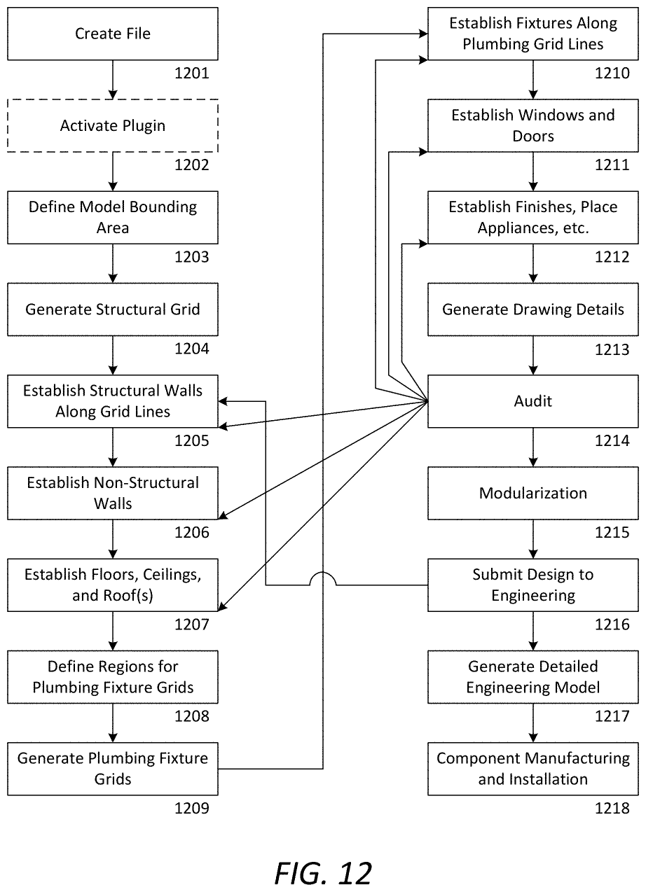

FIG. 12 is an alternate overall view of the design. At point 1201, the system initiates an architectural file. At point 1202, any requisite functionality may be initiated by, for example, installing a plugin or otherwise establishing the requisite functionality such that the functions described herein including auditing, flagging, and establishing options may be offered to the architectural designer. Point 1203 calls for defining a model bounding area, which may include the property line, the anticipated buildable area, or other area where the structure will be located. Point 1204 calls for defining a structural grid, such as a grid made up of a series of 24 inch by 24 inch squares. Point 1205 calls for the designer selecting from available wall options and creating structural walls, such as along grid lines. While not strictly restricted to grid lines, placing walls along grid lines when possible can offer a level of continuity and ease of construction. Preparing walls or other components of irregular sizes can potentially be problematic, but not impossible.

The structural grid requires the user or designer to draw walls to grid points only in one embodiment. If the user attempts to draw the wall between grid points, one embodiment of the design ends the wall at the closest grid point, and corners are provided at grid corners.

Point 1206 calls for creating non-structural walls, and point 1207 establishes floors and a roof or ceilings. Point 1208 defines regions that may use plumbing fixture grids. As noted, identified bathrooms may include plumbing fixtures, but kitchens and other relevant areas (laundry rooms, etc.) may also benefit from defining plumbing fixture grids. Point 1209 generates the plumbing fixture grids. Plumbing fixture grids allow the user to place plumbing fixtures accurately.

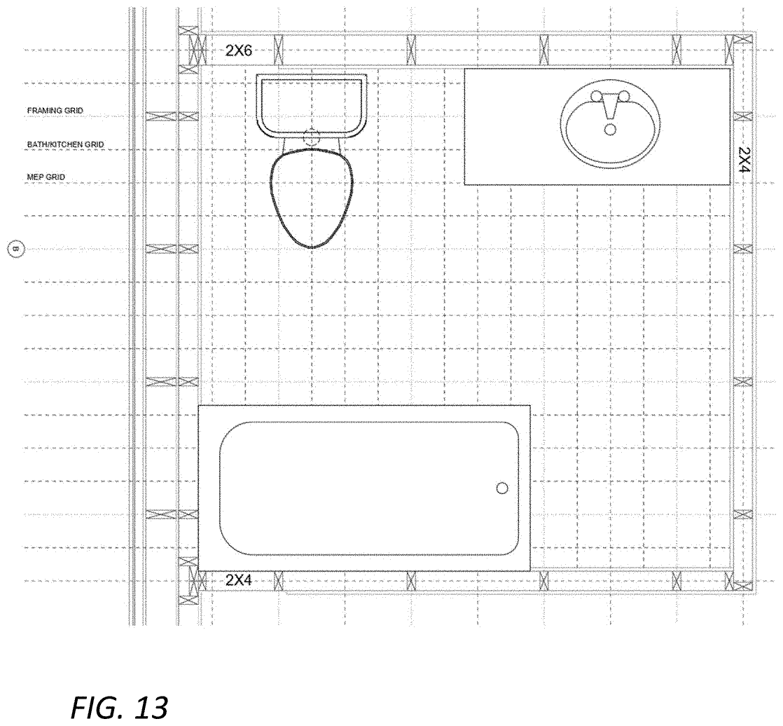

As may be seen in FIG. 8, the lines of the plumbing grid are typically smaller or closer together than the structural grid. The location of plumbing fixtures is constrained to points on this plumbing grid to avoid collision with structural framing. An alternate representation is shown in FIG. 13, with associated framing. The user may position a fixture (toilet, sink, tub, shower) on the grid, and the system will “snap” or position the fixture to the nearest plumbing grid point. Again, areas may require plumbing typically include bathrooms and kitchens, but other areas, such as an indoor bar with a sink, a washroom, laundry room, etc. may employ a plumbing grid to avoid plumbing running into structural framing members.

At point 1210, the system places fixtures along grid lines, while point 1211 places windows and doors in desired and available locations. Point 1212 defines available details including finishes, appliances, and so forth. Point 1213 is optional at this point, but calls for, when the plans are completed, the system generates standard drawing details.

The system can perform the aforementioned auditing function at any or all of points 1205 through 1207 and 1210 through 1213. For example, the system may allow for creating non-structural walls at point 1206, but the system may determine that a selected wall is not available, would not be shippable, or would not fit in the desired structure as desired, for example. Thus auditing may be performed at every step, or may be provided after multiple or all steps if desired. Point 1214 calls for employing the auditing function to perform a final check, and such a function may be optional. The result at this point may be called an architectural layout.

Point 1215 calls for running the modularization tool, modularizing the architectural layout as shown in, for example, FIG. 10. Point 1216 represents submission of the modularized architectural layout to engineering for approval and may include the system transmitting the modularized architectural layout electronically to an entity or device that performs engineering on the layout. A line is shown that is optional that enables engineering issues to be transmitted back to the architectural model as shown in FIG. 1. Once an issue is identified, the architectural model or the architect or operator may address the issue raised, may alter any necessary attributes, may audit the result, and may again transmit the modularized architectural layout to engineering or the engineering entity or device.

The present design may in certain instances offer a group of parts, or a kit, to the architectural designer operating the architectural model. Certain finishes, components, walls, panels, floors, ceilings, roofs, and so forth may be offered, generally within the ability of the entire system to modularize and transport the result. For example, if stone construction of exterior walls is desired, such materials may not be feasible for production and transportation and may not be offered. Thus as part of the present design, a “kit of parts” may be offered, but is not required nor used in all instances.

Point 1217 calls for the engineering approved design or model to be determined. Point 1218 calls for sending the engineering approved design for component manufacturing and installation deployment as shown in FIG. 1.

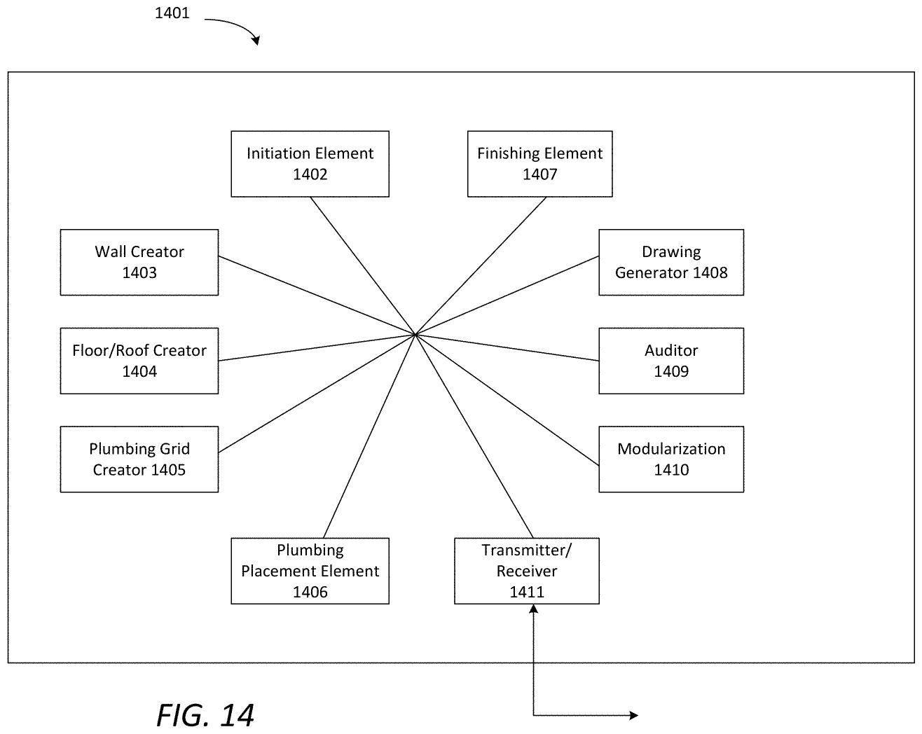

The present design may be implemented on a computing device. Certain functions or method steps may be performed by hardware, software, or firmware, or some combination, and may include the items shown in FIG. 14. From FIG. 14, processor 1401 is provided that may include the functional elements shown. Certain functional elements may be provided outside of processor 1401. Initiation element 1402 initiates the design, creating the architectural file, defining the boundary area, and setting up the structural grid. Selection of an alternate or complementary tool or set of functions may be offered.

Wall creator 1403 creates both structural and nonstructural walls on the established structural grid. Floor/roof creator 1404 facilitates the creation of floors and roofs, while plumbing region identifier facilitates identification of plumbing areas, or rooms or regions where plumbing will be located. Plumbing fixture grid creator 1405 creates the plumbing grid, and plumbing fixture placement element 1406 allows for placement of the plumbing fixtures such that no structural support element conflicts with the plumbing. Door/window placement element facilitates placement of doors and windows, while finishing element 1407 in this embodiment defines finishes, places appliances, and performs any other appropriate finishing tasks.

Drawing generator 1408 generates standard drawing details usable by engineering. Auditor 1409 may perform the auditing function discussed, and may perform auditing in connection with multiple elements provided herein. For example, after the roof has been selected, floor/roof creator 1404 may seek determine whether any issues exist with the proposed roof and may transmit the appropriate proposed roof details to auditor 1409. Auditor 1409 may find that inadequate support for the proposed roof has been provided, or excess support has been provided, and may flag the issue. The system or a user may then alter either the roof or the support elements to resolve the issue. Alternately, the system may perform all necessary processing and structure planning functionality shown and once the proposed design is completed may then perform the auditing function using auditor 1409. The result from the auditor may be provided back to drawing generator 1408 to create updated engineering compatible drawings.

Drawing generator 1408 may provide drawings to modularization element 1410, which may modularize the drawings created. Modularization element 1410 may interface with auditor 1409 to determine solutions to any modularization issues. For example, if a wall created is too large to transport when modularized, the auditor may be employed to resize or revise the wall in question or may flag the wall as unacceptable due to the modularization issue. The system may employ wall creator 1403 to create a new acceptable wall.

The present system may rely on multiple functions when an issue is identified. For example, a problem with a heavy roof may require additional structural support, which may in turn require different wall components to receive the added support, as well as may require alternate plumbing to avoid conflict between the new structural elements and plumbing for desired fixtures. Different fixtures may be needed. Thus the functional elements may operate together or be operated to facilitate an acceptable redesign.

Once all revisions have been completed and no auditing issues remain, the drawing generator may provide engineering ready drawings or drawing information to transmitter/receiver 1411, which may transmit the drawings to an engineering device or entity. Transmitter/receiver 1411 may also receive drawings and issues from the engineering device or entity (not shown in this view) and may provide those to the relevant components in FIG. 14 for resolution. For example, an issue with plumbing fixture placement may be provided to plumbing fixture placement element 1406.

The present design may offer additional attributes of the building components not previously available. A component or panel or an entire structure may employ carbon footprint values, for example, wherein carbon cost of obtaining the component and installing or otherwise providing the component is determined and provided with the component selected, and a total carbon footprint determined. Further, waterproofing attributes of components alone or when combined with other components may be determined and provided, and values summed for the entire structure when desired. The system may additionally provide other relevant performance based attributes or beneficial attributes of components.

Thus the present design provides an architecture construction method comprising, in certain instances, offering a set of selections of parts, components, or items. Functionality may be offered on a known software tool or as an add-on or plugin in one embodiment, added to a common architectural tool such as Autodesk or Revit. The system establishes a grid, such as a structure grid, and enables a designer to select and position aspects, components, panels, or other items of a proposed structure. Aspects that may be specified to the grid include but are not limited to structural walls, nonstructural walls, windows, roofs, and floors. The design allows for identification of areas wherein plumbing fixtures are to be placed, provides a plumbing fixture grid, and enables placement of plumbing fixtures to avoid conflict with structural elements. Once doors and windows are subsequently placed, the system provides the ability to provide finishing elements, such as finishes and appliances.

The present design provides an auditing function that identifies a series of requirements, potentially including owner requirements, local government requirements, logical requirements, and the like, and compares the proposed design against the known requirements to determine issues with such requirements. The auditor may provide a list of issues encountered and/or may address certain issues, such as absence of a toilet from a bathroom, etc., or may in appropriate circumstances solve more complex issues, such as correcting stairwells that would not be to local government ordinances. Modularization is contemplated with the present design, specifically the preparation of portions of the completely architected and engineered structure, and issues with modularization may be raised by the auditor and potentially addressed. Modularization issues may include inability to transport the resultant modularized component or panel, inability to fabricate the component or panel, and so forth. Once issues have been resolved, drawings may be prepared and transmitted to an engineering device or entity for engineering and approval.

Thus according to one embodiment of the present design, there is provided a method for providing a structure, comprising determining a set of building requirements applicable to the structure, establishing an architectural plan for the structure using a computing device, comprising establishing on a grid a set of modularized structural walls a from a set of available modularized structural walls using the computing device, establishing on the grid a set of modularized nonstructural walls from a set of available modularized nonstructural walls using the computing device, establishing doors and windows in association with the set of modularized structural walls and the set of modularized nonstructural walls using the computing device, and establishing locations for plumbing fixtures in selected regions within the set of modularized structural walls and the set of modularized nonstructural walls using the computing device such that plumbing fixtures are placed in positions avoiding conflict with structural elements in the set of modularized structural walls. The design further includes dividing, using the computing device, the architectural plan into a series of component parts transportable from a remote location to a property, thereby producing a modularized architectural plan, and comparing at least one of the architectural plan and modularized architectural plan to the set of building requirements and assessing whether at least one plan aspect fails to satisfy the set of building requirements.

According to a second embodiment, there is provided a method for providing a structure, comprising architecturally designing the structure, wherein architecturally designing the structure comprises establishing an architectural plan for the structure using a computing device, comprising establishing on a grid a set of modularized structural walls using the computing device, establishing on the grid a set of modularized nonstructural walls using the computing device, establishing doors and windows to be provided with the set of modularized structural walls and the set of modularized nonstructural walls using the computing device, and establishing locations for plumbing fixtures using the computing device in positions avoiding conflict with structural elements in the set of modularized structural walls. The design further includes dividing, using the computing device, the architectural plan into a series of component parts transportable from a remote location to a target property, thereby producing a modularized architectural plan and comparing at least one of the architectural plan and modularized architectural plan to a set of building requirements and assessing whether at least one plan aspect fails to satisfy the set of building requirements. The design further includes producing a final modularized architectural plan and preparing physical modular components according to the final modularized architectural plan and transporting the physical modular components to a target site and installing the physical modular components to build the structure.

According to a further embodiment, there is provided a method for providing a structure, comprising establishing an architectural plan for the structure using a computing device, comprising establishing on a grid a set of modularized structural walls using the computing device, establishing on the grid a set of modularized nonstructural walls using the computing device, establishing doors and windows to be provided with the set of modularized structural walls and the set of modularized nonstructural walls using the computing device, and establishing locations for plumbing fixtures using the computing device in positions avoiding conflict with structural elements in the set of modularized structural walls. The design further includes dividing, using the computing device, the architectural plan into a series of component parts transportable from a remote location to a target property, thereby producing a modularized architectural plan, and comparing at least one of the architectural plan and modularized architectural plan to a set of building requirements and assessing whether at least one plan aspect fails to satisfy the set of building requirements.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another, i.e. may include transitory and/or non-transitory computer readable media. A storage media may be any available media that can be accessed by a computer.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A method for providing a structure, comprising:
determining a set of building requirements applicable to the structure;
establishing an architectural plan for the structure using a computing device, comprising:
establishing on a grid a set of modularized structural walls a from a set of available modularized structural walls using the computing device;
establishing on the grid a set of modularized nonstructural walls from a set of available modularized nonstructural walls using the computing device;
establishing doors and windows in association with the set of modularized structural walls and the set of modularized nonstructural walls using the computing device; and
establishing locations for plumbing fixtures in selected regions within the set of modularized structural walls and the set of modularized nonstructural walls using the computing device such that plumbing fixtures are placed in positions avoiding conflict with structural elements in the set of modularized structural walls;
dividing, using the computing device, the architectural plan into a series of component parts transportable from a remote location to a property, thereby producing a modularized architectural plan; and
comparing at least one of the architectural plan and modularized architectural plan to the set of building requirements and assessing whether at least one plan aspect fails to satisfy the set of building requirements.

2. The method of claim 1, wherein establishing the architectural plan further comprises establishing at least one floor and at least one roof using the computing device.

3. The method of claim 1, further comprising addressing at least one identified area failing to satisfy the set of building requirements using the computing device by altering at least one of the architectural plan and modularized architectural plan.

4. The method of claim 1, wherein the building requirements comprise at least one of structural preferences of at least one owner or potential owner of the property, a governmental requirement, and a logistical physical requirement.

5. The method of claim 1, further comprising transmitting a completed version of the modularized architectural plan to an engineering entity or an engineering computing device using the computing device.

6. The method of claim 3, wherein addressing the at least one identified area failing to satisfy the set of building requirements comprises determining at least one alternative design option using the computing device.

7. The method of claim 2, wherein establishing the architectural plan further comprises:
establishing a set of finishes for hardware items in the architectural plan using the computing device; and
establishing locations for a set of appliances in the architectural plan using the computing device.

8. The method of claim 5, further comprising resolving issues of engineering using the computing device when engineering issues exist to produce a final architectural engineered plan, and subsequently manufacturing and installing structural components according to the final architectural engineered plan.

9. A method for providing a structure, comprising:
architecturally designing the structure, wherein architecturally designing the structure comprises:
establishing an architectural plan for the structure using a computing device, comprising:
establishing on a grid a set of modularized structural walls using the computing device;
establishing on the grid a set of modularized nonstructural walls using the computing device;
establishing doors and windows to be provided with the set of modularized structural walls and the set of modularized nonstructural walls using the computing device; and
establishing locations for plumbing fixtures using the computing device in positions avoiding conflict with structural elements in the set of modularized structural walls;
dividing, using the computing device, the architectural plan into a series of component parts transportable from a remote location to a target property, thereby producing a modularized architectural plan; and
comparing at least one of the architectural plan and modularized architectural plan to a set of building requirements and assessing whether at least one plan aspect fails to satisfy the set of building requirements;
producing a final modularized architectural plan and preparing physical modular components according to the final modularized architectural plan; and
transporting the physical modular components to a target site and installing the physical modular components to build the structure.

10. The method of claim 9, further comprising addressing at least one identified area failing to satisfy the set of building requirements using the computing device by altering at least one of the architectural plan and modularized architectural plan.

11. The method of claim 9, wherein the building requirements comprise at least one of structural preferences of at least one owner or potential owner of the target site, a governmental requirement, and a logistical physical requirement.

12. The method of claim 9, further comprising transmitting a completed version of the modularized architectural plan to an engineering entity or an engineering computing device using the computing device.

13. The method of claim 10, wherein addressing the at least one identified area failing to satisfy the set of building requirements comprises determining at least one alternative design option using the computing device.

14. The method of claim 12, further comprising resolving issues of engineering using the computing device when engineering issues exist to produce a final architectural engineered plan, and subsequently manufacturing and installing structural components according to the final architectural engineered plan.

15. A method for providing a structure, comprising:
establishing an architectural plan for the structure using a computing device, comprising:
establishing on a grid a set of modularized structural walls using the computing device;
establishing on the grid a set of modularized nonstructural walls using the computing device;
establishing doors and windows to be provided with the set of modularized structural walls and the set of modularized nonstructural walls using the computing device; and
establishing locations for plumbing fixtures using the computing device in positions avoiding conflict with structural elements in the set of modularized structural walls;
dividing, using the computing device, the architectural plan into a series of component parts transportable from a remote location to a target property, thereby producing a modularized architectural plan; and
comparing at least one of the architectural plan and modularized architectural plan to a set of building requirements and assessing whether at least one plan aspect fails to satisfy the set of building requirements.

16. The method of claim 15, further comprising producing a final modularized architectural plan and preparing physical modular components according to the final modularized architectural plan.

17. The method of claim 16, further comprising transporting the physical modular components to a target site and installing the physical modular components to build the structure.

18. The method of claim 15, wherein establishing the architectural plan further comprises establishing at least one floor and at least one roof using the computing device.

19. The method of claim 15, wherein the building requirements comprise at least one of structural preferences of at least one owner or potential owner of the property, a governmental requirement, and a logistical physical requirement.

20. The method of claim 15, further comprising providing information about at least one element of the architectural plan to a user, the information comprising at least one of carbon footprint, recycling attributes, size, weight, a listing of building specifications, cost of upgrade options, heating load, cooling load, annual resource consumption, and maintenance attributes of the element.
